(19) United States
(12) Patent Application Publication
(10) Pub. No.: US 2010/0002213 A1
(43) Pub. Date: Jan. 7, 2010

(54) PHOTOLITHOGRAPHY SYSTEM USING AN OPTICAL MICROSCOPE

(75) Inventors: Gyu-Tae Kim, Gyeonggi-do (KR); Eung-Seok Park, Seoul (KR); Do-Young Jang, Seoul (KR); Jae-Woo Lee, Seoul (KR)

Correspondence Address: LRK Patent Firm, 1952 Gallows Rd Suite 200, Vienna, VA, 22182, US

(73) Assignee: Korea University Industrial & Academic Collaboration Foundation, Seoul (KR)

(21) Appl. No.: 12/033,264

(22) Filed: Feb. 19, 2008

(30) Foreign Application Priority Data
Jan. 8, 2008 (KR) 10-2008-0002104

(51) Int. Cl. G03B 27/52

(52) U.S. Cl. 355/55

(57) ABSTRACT

A photolithography system using an optical microscope is provided that can form various types of selective patterns at a low cost in small-scale research using unit-size silicon substrates which is not targeted for mass production, without requiring an expensive photomask.

### CROSS-REFERENCE TO RELATED APPLICATION

The benefit of priority is claimed to Republic of Korea Patent Application No. 10-2008-0002104, filed with the Korean Intellectual Property Office on Jan. 8, 2008, which is incorporated by reference herein in its entirety.

### INTRODUCTION

The present discussion relates to a photolithography system using an optical microscope, and more particularly to a photolithography system using an optical microscope which can form, without using an expensive photomask, various types of selective patterns at a low cost in small-scale research using unit-size silicon substrates which is not targeted for mass production.

### RELATED ART

Research and development of semiconductors such as next-generation electronic devices require photolithography for metal deposition or etching to form a desired pattern.

Photolithography is an indispensable technology used in conventional semiconductor processes. In this technology, a thin layer of a chemical material (i.e., photoresist), which is sensitive to light having a specific wavelength and undergoes a change in the properties upon exposure to the light, is coated on a semiconductor substrate and desired portions of the photoresist are then selectively exposed to the light to form patterns.

Here, a mask made of material such as metal which does not transmit light or a film mask which has highly defined black and white portions is used to divide the photoresist into portions of the photoresist to be exposed and portions to be unexposed.

Photolithography equipment can process patterns including those in units down to micrometers and can repeatedly use a single manufactured mask and also provides high processing speed. Due to these advantages, the photolithography equipment is used as an indispensable device in current semiconductor industries.

However, it is not easy to access the conventional photolithography equipment in the research stage since it is designed for mass production and is expensive and it also requires the process of manufacturing masks.

Masks-which are indispensable in photolithography processes-are also expensive. In addition, once a mask is manufactured, it cannot be altered. Also, forming complex structures generally requires several masks.

Due to these limitations of conventional photolithography equipment, there has been a need for photolithography equipment that is easy to access and which can selectively form a small number of various patterns during the research stage, such as research on next-generation semiconductors, which is targeted at manufacturing a small number of devices rather than a large number of devices.

Some solutions to the above problems use equipment such as e-beam lithography or atomic force microscope lithography equipment at the research stage.

However, compared to conventional photolithography equipment, such lithography equipment requires a long time to manufacture devices and has low usability since the price and cost of manufacturing equipment is high.

### SUMMARY

Therefore, in view of the above and other various problems, a lithography system is provided that uses an optical microscope, in which selective patterns can be formed using the optical microscope without using expensive lithography equipment, and which is easy to use in laboratories (such as in the research stage) that is targeted at manufacturing a small number of devices such as next-generation semiconductors.

It is another object to provide a lithography system using an optical microscope, which can replace conventional photolithography equipment required for processes of manufacturing semiconductors with the optical microscope so that it is possible to omit both processes of manufacturing masks and processes using masks which are indispensable in conventional photolithography processes, thereby reducing the manufacturing cost and the manufacturing process time of semiconductors.

In accordance with the present discussion, the above and other objects may be accomplished by a photolithography system using an optical microscope, the photolithography system including an optical microscope unit for focusing a light beam having a wavelength onto a surface of a photoresist coated on a substrate, the photoresist being sensitive to the wavelength of the light beam; a stage unit mounted under the optical microscope unit, the stage unit moving the substrate coated with the photoresist mounted on the stage unit such that light is radiated only to desired portions of the photoresist; and a controller for controlling the system including the optical microscope unit and the stage unit.

The optical microscope unit may include a light source for generating a light beam having a wavelength to which the photoresist is sensitive; a light controller including an iris and a blanker, the iris being mounted in a path of the light beam generated by the light source to decrease, increase, or modulate a cross-sectional shape of the light beam, the blanker blocking the light beam generated by the light source such that the light beam is not radiated to an undesired region of the photoresist when the light beam is radiated to the photoresist according to a pattern having separate parts to be formed on the substrate; an optical microscope for passing and focusing the light beam that has passed through the light controller onto a surface of the substrate coated with the photoresist.

The light source may selectively generate a light beam having a wavelength to which the photoresist coated on the substrate is sensitive.

The optical microscope may focus the light beam generated by the light source onto the surface of the substrate coated with the photoresist such that the light beam is radiated only onto portions for patterning of the photoresist to perform photolithography.

The stage unit may include a first stage movable in an X-axis direction; a second stage combinable with the first stage such that the second stage is movable in a Y-axis direction; and a drive motor for driving the first and second stages.

The controller may include a light source control module for controlling the light source of the optical microscope unit to generate a light beam and controlling the blanker and the iris of the light controller; a stage control module for precisely controlling an operation of the stage unit in units of micrometers; and a data processing module for analyzing a pattern, transmitting a control signal required to control the light source to the light source control module, and transmitting a control signal for accurately moving the stage unit to the stage control module.

The controller may analyze the shape and size of a pattern input by a user to determine the cross-sectional shape and size of the light beam and may control the light controller based on the determination and precisely control movement of the stage unit according to the pattern.

The controller may further include an interface module for interfacing with the optical microscope unit and the stage unit and for monitoring a course of pattern formation through the optical microscope unit.

### BRIEF DESCRIPTION OF THE DRAWINGS

The above and various other objects, features and other advantages of the present invention will be more clearly understood from the following detailed description taken in conjunction with the accompanying drawings, in which:

FIG. 1 schematically illustrates a photolithography system using an optical microscope according to an embodiment;

FIG. 2 is a block diagram of the photolithography system illustrated in FIG. 1;

FIGS. 3A and 3B illustrate a program screenshot and an internal architecture of a controller in the photolithography system according to an embodiment; and

FIG. 4 illustrates an example pattern formed with the photolithography system using an optical microscope according to the embodiment.

### DETAILED DESCRIPTION

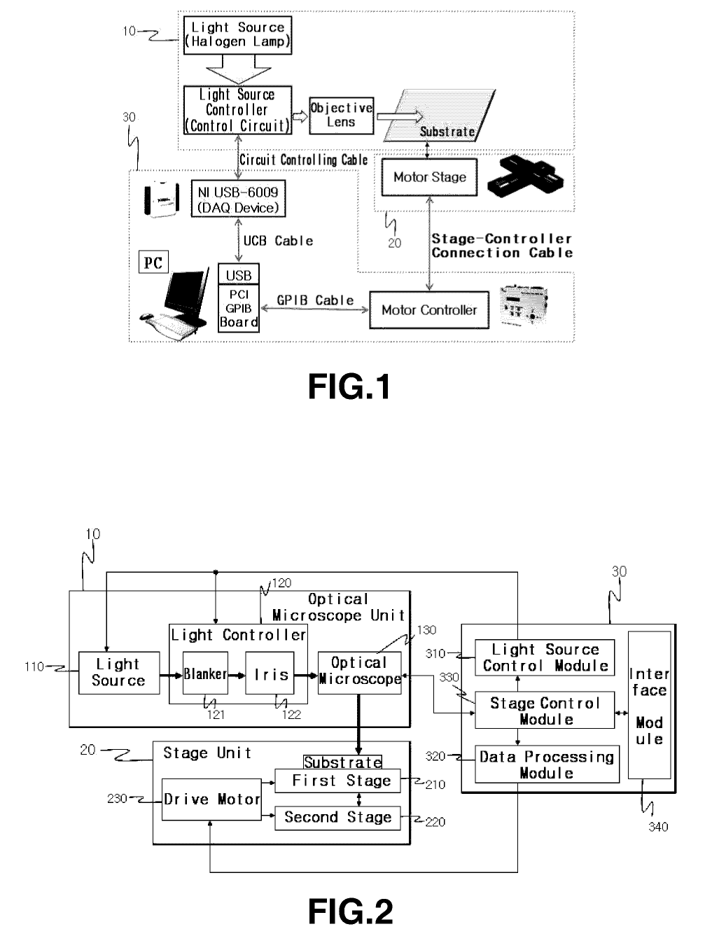

Various embodiments will now be described in detail with reference to the accompanying drawings. FIG. 1 schematically illustrates a photolithography system using an optical microscope according to at least one embodiment. FIG. 2 is a block diagram of the photolithography system illustrated in FIG. 1.

As shown in FIGS. 1 and 2, the optical photolithography system may include an optical microscope unit 10, a stage unit 20, and a controller 30.

More specifically, the optical microscope unit 10 focuses a light beam having a wavelength, to which a photoresist is sensitive, onto the surface of the photoresist coated on a substrate, thereby performing photolithography.

Here, the optical microscope unit 10 may include a light source 110, a light controller 120, and an optical microscope 130. The light source 110 generates a light beam having a wavelength to which the photoresist is sensitive. The light controller 120 includes a blanker 121 and an iris 122. The blanker 121 blocks a light beam generated by the light source 110 such that a region of the photoresist between separate parts of a pattern to be formed on the substrate is not exposed to the light beam while the pattern is drawn on the photoresist. The iris 122 is mounted in the path of the light beam generated by the light source 110 to decrease, increase, or modulate the cross-sectional shape of the light beam. The optical microscope 130 passes and focuses the light beam that has passed through the light controller 120 onto the surface of the substrate coated with the photoresist, thereby performing photolithography.

The light source 110 generates a light beam having a wavelength in a band to which the photoresist is sensitive so that photolithography is achieved through reaction of the photoresist coated on the substrate with the light beam.

To accomplish this, the light generated by the light source 110 needs to have a wavelength to which commercial photoresists are sensitive so that the light can change the properties of a photoresist coated on the substrate when the photoresist is exposed to the light.

For example, the light source 110 can generate light having a wavelength in an ultraviolet (UV) band since UV radiation is generally used to cause photoreaction of common photoresists.

Photoresists generally used for photolithography exhibit changes in their properties at a wavelength with high energy in a band that ranges from visible light below a bright-yellow wavelength to ultraviolet light.

A halogen lamp which is provided in the optical microscope may be used as the light source 110 for the microscope photolithography. If exposure is done for a sufficiently long time when the halogen lamp is used, it is possible to change the properties of the photoresist since the halogen lamp generates white light having a wide range of wavelengths.

The light controller 120 basically needs to be able to determine the size of each pattern to be formed and to adjust the cross-sectional size of a light beam which has passed through the iris 122 and to block light using the blanker 121 as needed in order to form a pattern having physically separated parts.

To accomplish this, the blanker 121 can be constructed in any shape which can be closed or opened to selectively block or pass light to be incident on the substrate through the optical microscope when the substrate is moved according to a pattern having separate parts to be formed on the substrate.

The optical microscope 130 may be a generally used optical microscope. The light source 110 and the light controller 120 are combined to construct the optical microscope unit 10.

The optical microscope 130 focuses the light beam generated by the light source 110, which has passed through the light controller 120, onto the surface of the substrate coated with the photoresist to achieve precise patterning, while the movement of the stage unit 20 described below is controlled to radiate the light beam only to portions for patterning of the photoresist, thereby performing photolithography to obtain a desired pattern.

The stage unit 20 is mounted under the optical microscope unit 10 and is responsible for moving the substrate coated with the photoresist mounted on the stage unit 20 such that light is radiated only to desired portions of the photoresist.

To accomplish this, the stage unit 20 can be constructed to be movable in two (X and Y-axis) directions using means for precisely controlling a position for pattering on the substrate coated with the photoresist (i.e., for precisely controlling a portion of the substrate to which light is radiated through the optical microscope).

More specifically, the stage unit 20 may include a first stage 210 that is movable in the X or Y-axis direction, a second stage 210 that is combined with the first stage 210 such that it is movable in the Y or X-axis direction, and a drive motor 230 for driving the first and second stages.

The first and second stages 210 and 220 can be constructed in a structure in which they cross each other, one on top of the other. Here, the substrate coated with the photoresist is located on the upper one of the first and second stages.

The controller 30 controls all components of the system including the optical microscope unit 10 and the stage unit 20. The controller 30 is also responsible for analyzing a preset pattern for accurate pattern processing, transferring a control command required for photolithography to the optical microscope unit 10 and the stage unit 20, and checking the state of the photolithography.

More specifically, the controller 30 includes a light source control module 310, a stage control module 320, and a data processing module 330. The light source control module 310 controls the light source 110 of the optical microscope unit 10 to generate light and controls the blanker 121 and the iris 122 of the light controller 120. The stage control module 320 precisely controls the operation of the stage unit 20 in units of micrometers. The data processing module 330 functions as a CPU which analyzes the pattern, transmits a control signal required to control the light source to the light source control module, and transmits a control signal for accurately moving the stage unit 20 to the stage control module.

The light source control module 310 transmits a control signal for generating a light beam having a wavelength to which the photoresist is sensitive to the light source 110, controls the iris 122 based on the cross-sectional size of the light beam according to the shape of the pattern, and transmits a signal for controlling the blanker 121 according to the shape of the pattern to perform precise control of the light source 110 and the light controller 120.

The stage control module 320 is a motor driver for controlling the operation of the drive motor 230 which drives the stage unit 20. The stage control module 320 is responsible for precisely controlling the movement of the first and second stages 210 and 220 to control the position for patterning on the substrate.

The data processing module 330 may include therein a microprocessor which can automatically perform, when a desired pattern to be formed on the substrate is input, optimal control of the light source control module 310 and the stage control module 320 according to the input pattern.

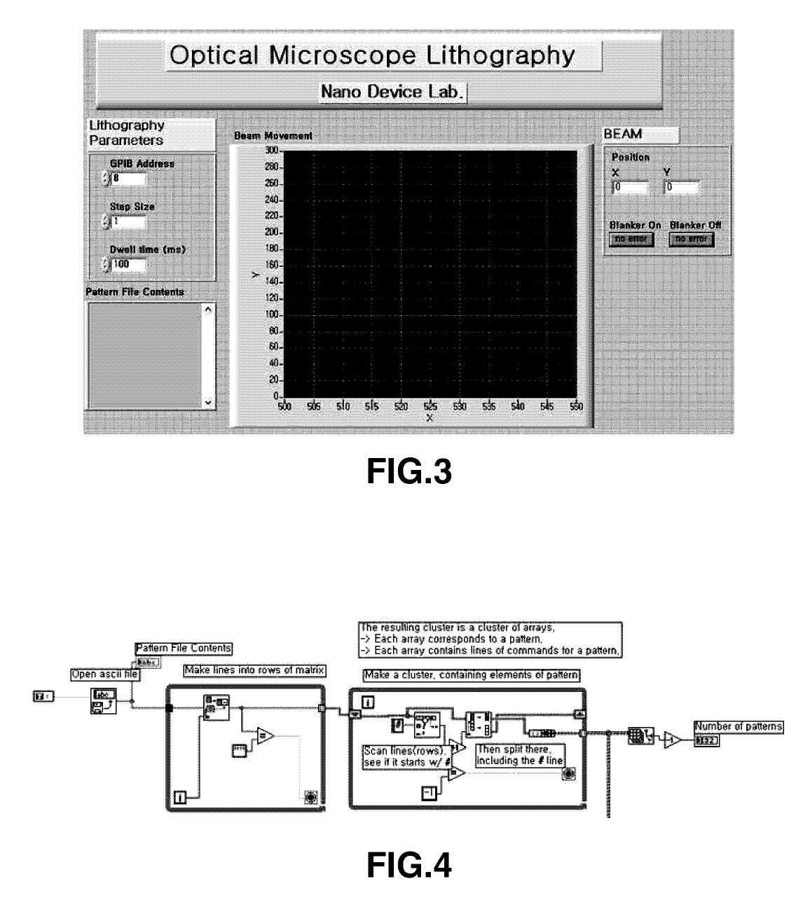

FIGS. 3A and 3B illustrate a program screenshot and an internal architecture of the controller.

As shown in FIGS. 3A and 3B, the data processing module 330 of the controller 30 can analyze the pattern so that desired positions are exposed to light and can control the photolithography system through a program that controls the light source and the drive motor.

The program that performs such control operations can be written using any programming language which supports a function to control an interface provided by the stage unit and the light controller such as a General Purpose Interface Bus (GPIB), RS232, or a Universal Serial Bus (USB).

The program may include an algorithm which efficiently controls the size of the pattern to be formed based on the cross-sectional shape and size of the light beam.

For example, if the cross-sectional size of the light beam is decreased using the iris, it is possible to form finer patterns and also to apply basic lithography techniques such as alignment and mix & match techniques in the process of forming a pattern in a two-dimensional plane.

Reference will now be made to an example lithography method. First, a substrate coated with a photoresist is placed on the stage unit 20 coupled to a lower portion of the optical microscope unit 10.

Then, when the user inputs a desired pattern form or shape through the interface module 340, the controller 30 causes the light source 110 of the optical microscope unit 10 to generate a light beam having a wavelength to which the photoresist coated on the substrate is sensitive and opens the blanker 121 according to the pattern to allow the light beam to pass through the blanker 121. The controller 30 also analyses the shape of the pattern input by the user to determine the cross-sectional shape and size of the light beam and to control the iris 122 so that the light beam is incident on the optical microscope 130 through the iris 122.

Here, a focused light beam exiting an objective lens of the optical microscope 130 is fixed to the portion for patterning of the substrate coated with the photoresist.

The stage control module 320 of the controller 30 then controls the drive motor 230 to move the first and second stages 210 and 220 in the X and Y-axis directions based on pattern analysis to precisely control the portion for patterning of the photoresist such that light is radiated to the portion for patterning. Here, the irradiated portion of the photoresist undergoes changes in its properties through photoreaction. Thereafter, the sample is immersed in a developing liquid to remove or leave only the irradiated portion to form the pattern on the substrate.

During the development, only the irradiated portion is removed to form the pattern on the substrate during development if the photoresist is of positive type and only the irradiated portion is left to form the pattern on the substrate during development if the photoresist is of negative type.

Here, while the substrate moves with the light beam spot passing over a region of the photoresist between separate parts of a pattern to be formed on the substrate (i.e., while the substrate moves with the light beam spot passing over an area of the photoresist where irradiation is unnecessary), the blanker is closed to block the light beam generated by the light source 110 to prevent the light beam from being incident on the substrate through the optical microscope. The blanker 121 is constructed in the form of a screen at the light-emitting opening of the light source 110 such that it blocks or passes light according to a selection (on/off) signal. The blanker is opened to pass light when exposure is necessary and is closed to block light when exposure is unnecessary.

As shown in FIG. 3A, the program according to at least one example embodiment can be designed to allow the user to control the dwell time during which the stage stays at a position and the distance from the position to the next position to move to in order to control the intensity of radiated light according to the type or shape of the pattern. The program also allows the user to view the movement of the position of the stage through the coordinates and graph on a display.

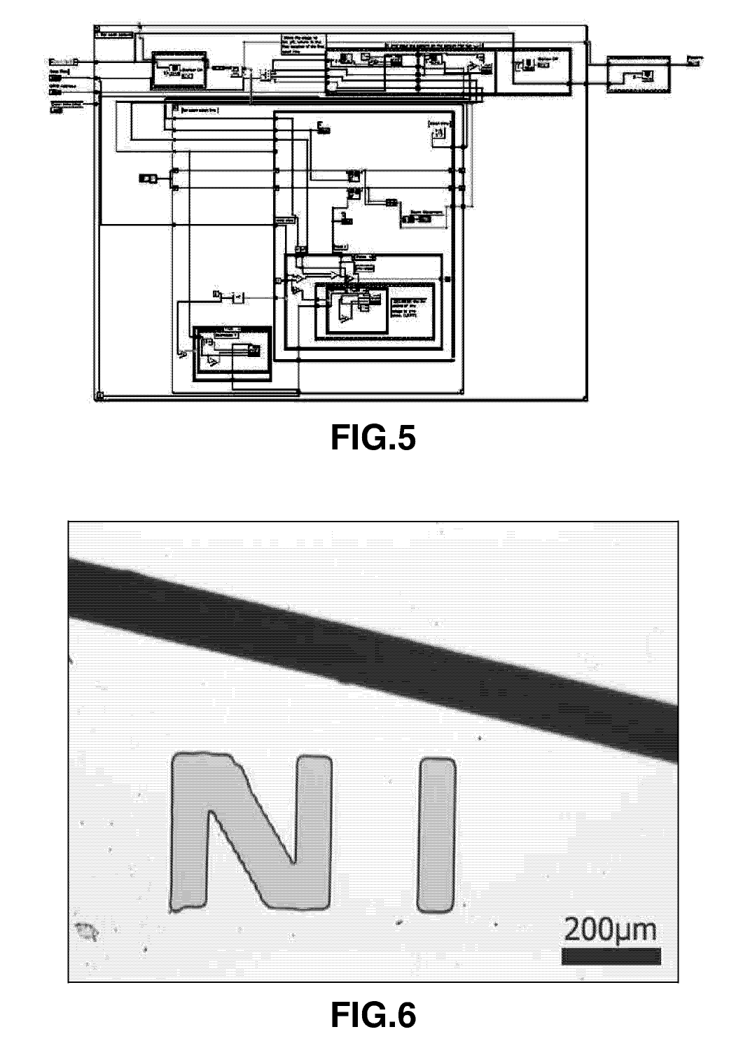

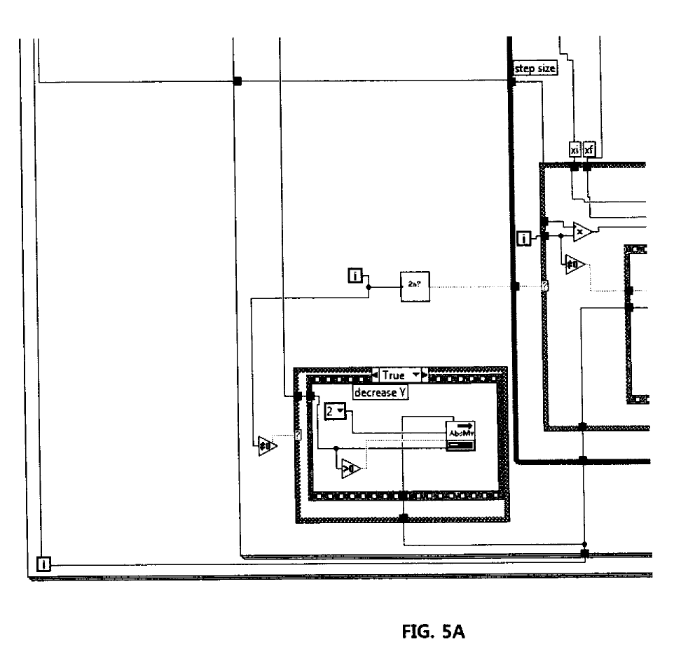

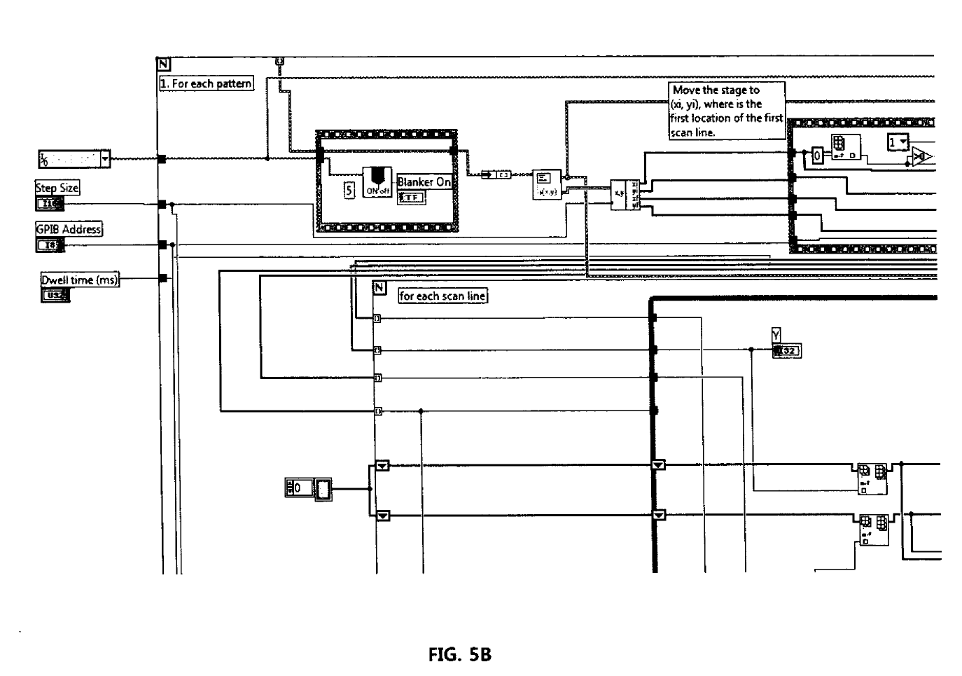

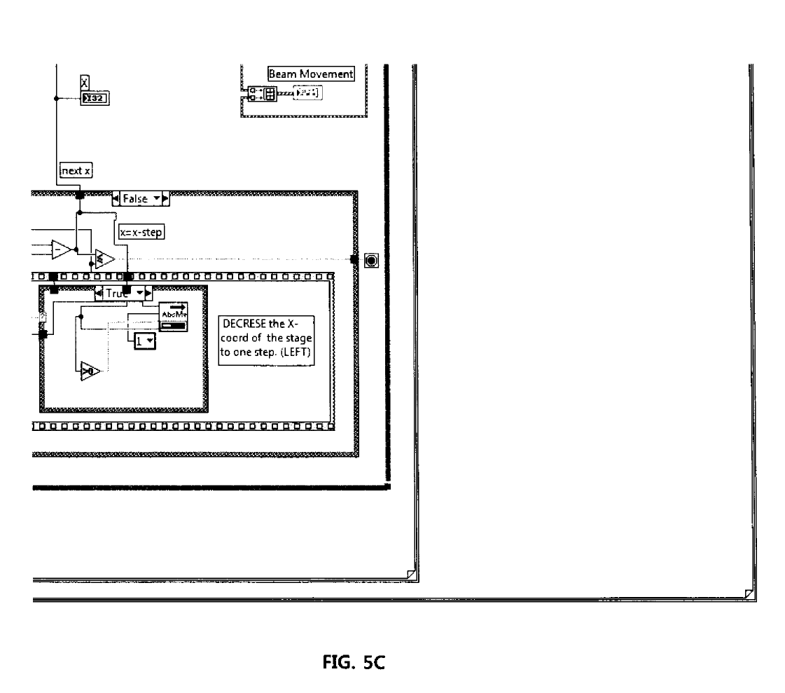

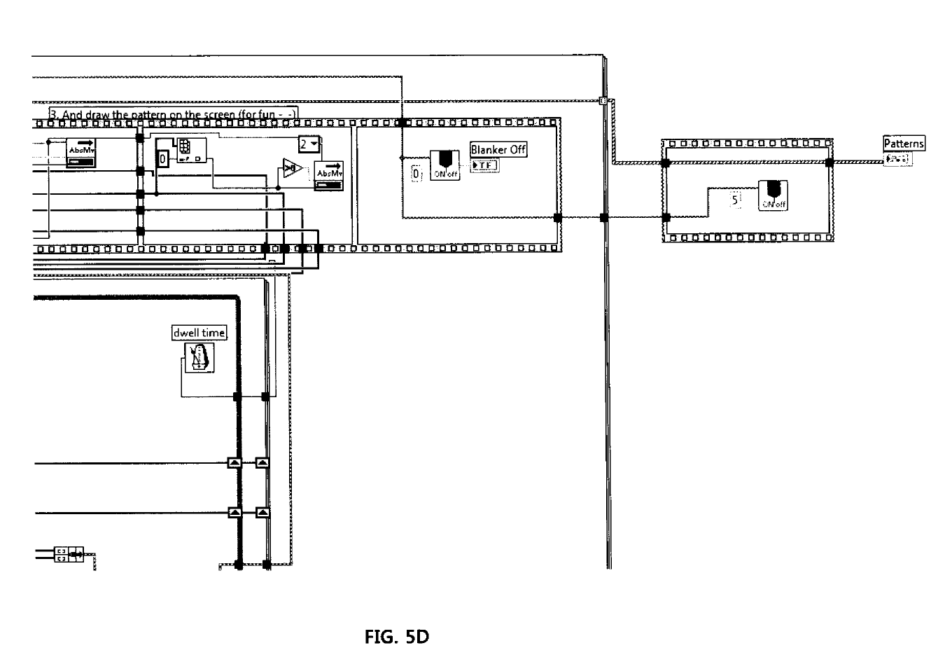

FIG. 4 illustrates an example pattern formed with the photolithography system using an optical microscope. In the example of FIG. 4, first, a pattern “NI” is created and stored as a file on a computer. Using the photolithography system using an optical microscope, the pattern is analyzed and portions on a substrate coated with a photoresist are selectively exposed to light. The photoresist is then developed to form the pattern “NI” on the substrate as shown in FIG. 4. Here, to confirm the size of the pattern, we compared it with the size of a strand of hair.

From the above description, it can be seen that the photolithography system using an optical microscope can adjust the cross-sectional size and shape of a light beam to be radiated and also can selectively manufacture various types of patterns in units of micrometers through accurate control of the motor-driven stages.

Thus, the photolithography system using an optical microscope has a variety of advantages. For example, the photolithography system may use a conventional optical microscope in place of expensive conventional lithography equipment in research activities for manufacturing next-generation semiconductor devices. Thus, the present photolithography system can eliminate the need to use the expensive conventional lithography equipment, thereby reducing the price and cost of manufacturing equipment.

In addition, since there is no need to prepare masks, the present example photolithography system may eliminates the time and cost required to manufacture masks and to perform mask-based processes. The photolithography system also has excellent equipment management and repair characteristics since it uses an optical microscope which is employed in conventional processes of manufacturing semiconductor devices. The photolithography system can process a small number of various patterns so that it can be efficiently used in laboratories where the usability of conventional photolithography equipment is low. Thus, the present photolithography system can contribute to increasing the activities of not only semiconductor-related research but also research which requires relevant similar or related technologies.

Although various non-limiting example embodiments of the present invention have been disclosed for illustrative purposes, those skilled in the art will appreciate that various modifications, additions and substitutions are possible, without departing from the scope and spirit of the invention, as set forth in the accompanying claims.

What is claimed is:

1. A photolithography system using an optical microscope, the photolithography system comprising:
an optical microscope unit configured to focus a light beam having a wavelength onto a surface of a photoresist coated on a substrate, the photoresist being sensitive to the wavelength of the light beam;
a stage unit mounted under the optical microscope unit, the stage unit configured to move the substrate coated with the photoresist mounted on the stage unit such that light is radiated only to one or more intended portions of the photoresist; and
a controller configured to control the photolithography system including the optical microscope unit and the stage unit.

2. The photolithography system according to claim 1, wherein the optical microscope unit includes:
a light source configured to generate a light beam having a wavelength to which the photoresist is sensitive;
a light controller including an iris and a blanker, the iris being mounted in a path of the light beam generated by the light source and configured to decrease, increase, and/or modulate a cross-sectional shape of the light beam, the blanker configured to block the light beam generated by the light source such that the light beam is not radiated to an unintended region of the photoresist when the light beam is radiated to the photoresist according to a pattern having separate parts to be formed on the substrate;
an optical microscope configured to pass and focus the light beam that has passed through the light controller onto a surface of the substrate coated with the photoresist.

3. The photolithography system according to claim 2, wherein the light source selectively generates a light beam having a wavelength to which the photoresist coated on the substrate is sensitive.

4. The photolithography system according to claim 2, wherein the optical microscope focuses the light beam generated by the light source onto the surface of the substrate coated with the photoresist such that the light beam is radiated only to portions for patterning of the photoresist to perform photolithography.

5. The photolithography system according to claim 1, wherein the stage unit includes:
a first stage movable in an X-axis direction;
a second stage combined with the first stage such that the second stage is movable in a Y-axis direction; and
a drive motor configured to drive the first and second stages.

6. The photolithography system according to claim 2, wherein the controller includes:
a light source control module configured to control the light source of the optical microscope unit to generate a light beam, and to control the blanker and the iris of the light controller;
a stage control module configured to precisely control an operation of the stage unit in units of micrometers; and
a data processing module configured to analyze a pattern, to transmit a control signal required to control the light source to the light source control module, and to transmit a control signal for accurately moving the stage unit to the stage control module.

7. The photolithography system according to claim 6, wherein the controller analyzes a shape and size of a pattern input by a user to determine a cross-sectional shape and size of the light beam and controls the light controller based on the determination and precisely controls movement of the stage unit according to the pattern.

8. The photolithography system according to claim 6, wherein the controller further includes an interface module configured to interface with the optical microscope unit and the stage unit, and to monitor a course of pattern formation through the optical microscope unit.
